(19) United States
(12) Patent Application Publication
(10) Pub. No.: US 2019/0073634 A1
(43) Pub. Date: Mar. 7, 2019

(54) METHOD AND PROGRAM FOR PROVIDING COLLABORATION SERVICE

(71) Applicant: O2PALM INC., Daejeon (KR)

(72) Inventor: Sung Youn HONG, Songpa-gu (KR)

(73) Assignee: O2PALM INC., Daejeon (KR)

(21) Appl. No.: 16/183,968

(22) Filed: Nov. 8, 2018

Related U.S. Application Data
(63) Continuation of application No. PCT/KR2018/006386, filed on Jun. 5, 2018.

(30) Foreign Application Priority Data
Jun. 7, 2017 (KR) 10-2017-0070655

(51) Int. Cl. G06Q 10/10; G06Q 30/06

(52) U.S. Cl. CPC G06Q 10/103; G06Q 30/0635

(57) ABSTRACT

A method and program for providing a collaboration service is provided. The method includes generating, by a service server, a project corresponding to a collaboration group, receiving, by the service server, card data from a user client in a main board in the project and generating, by the service server, a default card, the card data being information input to the project, receiving, by the service server, a request to input a label to the card data, connecting, by the service server, the card data to an expansion board corresponding to the label, and displaying, by the service server, card data connected by a specific label on the expansion board.

### CROSS-REFERENCE TO RELATED APPLICATIONS

The present application is a continuation of International Patent Application No. PCT/KR2018/006386, filed on Jun. 5, 2018 which is based upon and claims the benefit of priority to Korean Patent Application No. 10-2017-0070655, filed on Jun. 7, 2017. The disclosures of the above-listed applications are hereby incorporated by reference herein in their entirety.

### BACKGROUND

Embodiments of the inventive concept described herein relate to a method and program for providing a collaboration service, and more particularly, relate to a method and program for a collaboration function to be matched with each industry sector.

With the spread of smart devices such as smartphones or smart pads, there has been a growing trend towards an enterprise mobility service (EMS) environment capable of working in conjunction with a legacy system of the enterprise.

The EMS environment may enhance business efficiency and may reduce waste of time or cost by quickly and accurately facilitating a variety of field supervision of the enterprise. Particularly, the EMS environment has emerged in utilization in marketing, sales, or production lines.

Meanwhile, there has been a growing trend to perform tasks through collaboration between members who participate in a variety of tasks inside or outside the enterprise. There has been a need for various functions for providing a function in consideration of collaboration and efficiently generating collaboration products in the EMS environment.

However, it is common practice that a conventional EMS environment provides a function of inputting and displaying data using a general mobile web browser or a business app. Thus, there is a need for developing a collaboration environment capable of effectively exchanging information between members who participate in tasks inside or outside the enterprise and simply providing business products through collaboration in the form of electronic documents.

Furthermore, recently, a universal collaboration service has appeared other than a collaboration service developed for a specific enterprise. However, a user interface of the collaboration service is fixed, so the collaboration service does not reflect a characteristic which differs per industry sector.

### SUMMARY

Embodiments of the inventive concept provide a method and program for providing a collaboration service to provide an information providing page (i.e., a board) suitable for each industry sector such that the information providing page is simply written and use the collaboration service to be suitable for each industry sector.

According to an aspect of an embodiment, a method for providing a collaboration service may include generating, by a service server, a project corresponding to a collaboration group, receiving, by the service server, card data from a user client in a main board in the project and generating, by the service server, a default card, the card data being information input to the project, receiving, by the service server, a request to input a label to the card data, connecting, by the service server, the card data to an expansion board corresponding to the label and displaying, by the service server, card data connected by a specific label on the expansion board, wherein the expansion board is a board of a specific format used for each situation or each industry sector.

The connecting of the card data comprises, displaying an expansion card modified to a format corresponding to the expansion board corresponding to the label.

The project comprises one or more spaces and wherein the space corresponds to one or more detailed groups in the collaboration group.

The method may further include, as a user included in the collaboration group purchases a specific new skin in the project, adding, by the service server, any one of an expansion space, an expansion board, and an expansion card included in the new skin to the project, wherein the purchasing of the new skin is performed in a market in a collaboration service.

The expansion board is generated based on a format used in a specific field, and wherein an expansion card included in the expansion board displays only information which should be displayed on the expansion board in a specific format among data included in the default card.

The method may further include, when a specific card data is corrected in the main board or the expansion board by a specific user in the collaboration group, displaying, by the service server, the corrected expansion card data within one or more expansion boards, wherein the main board and the expansion board display the same information as default card data and expansion card data of different formats depending on a board type.

The card data comprises related user information as a label in a corresponding card, the method may further include, when the card data is corrected, notifying only a user included in information about an interested party that the card data is corrected.

The method may further include, when a collaboration service is used for filming, the default card is generated for each scene included in a scenario, the expansion board corresponds to a shooting schedule, and an expansion card included in the shooting schedule is a card generated by merging a plurality of default cards where a specific date is set to a filming schedule in a schedule label and is assigned in order of filming date.

The receiving of the card data comprises, receiving a request to divide scenario data and generating a default card corresponding to each scene.

According to another aspect of an embodiment, a program for providing a collaboration service may be combined with a computer which is hardware to execute the above-mentioned method and may be stored in a medium.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a flowchart illustrating a method for providing a collaboration service according to an embodiment of the inventive concept;

FIG. 2 is a drawing illustrating a default card generated for each scene in film production according to an embodiment of the inventive concept;

FIG. 3 is a drawing illustrating a per-scene default card to which a schedule label is added, according to an embodiment of the inventive concept;

FIG. 4 is a drawing illustrating a process of generating an expansion card (a daily shooting schedule) of a shooting schedule which is an expansion board based on a default card in film production according to an embodiment of the inventive concept;

FIG. 5 is a flowchart illustrating a method for providing a collaboration service, which further includes a process of correcting a linked card depending on correction of a specific default card or a specific expansion card according to an embodiment of the inventive concept;

FIG. 6 is a drawing illustrating an expansion card (a daily shooting schedule) generated by including several default cards according to an embodiment of the inventive concept; and

FIG. 7 is a flowchart illustrating a method for providing a collaboration service, which further includes a process of adding a new skin to a project or space according to an embodiment of the inventive concept.

### DETAILED DESCRIPTION

The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept are provided to make the disclosure of the inventive concept complete and fully inform those skilled in the art to which the inventive concept pertains of the scope of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. Throughout the specification, the same reference numerals dente the same elements, and “and/or” includes the respective elements and all combinations of the elements. Although “first”, “second” and the like are used to describe various elements, the elements are not limited by the terms. The terms are used simply to distinguish one element from other elements. Accordingly, it is apparent that a first element mentioned in the following may be a second element without departing from the spirit of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, exemplary embodiments of the inventive concept will be described in detail with reference to the accompanying drawings.

The term “collaboration group” in the specification may refer to a group in an online service, configured to include a plurality of users and perform collaboration.

The term “detailed group” in the specification may refer to a sub-group included in a specific collaboration group.

The term “project” in the specification may refer to a space generated such that a specific collaboration group exchanges information to perform collaboration. For example, in case of a group including a user (e.g., staff, an actor or actress, or the like) which is involved in specific film production, the term “project” may refer to a space where users of the group involved in specific film production exchange information.

The term “space” in the specification may refer to one or more detailed spaces included in a project. In other words, the term “space” may refer to a space for receiving information added from a user client device included in a specific collaboration group.

The term “main board” in the specification may refer to a user interface screen displayed in a manner to arrange data input or uploaded by a user included in a collaboration group.

The term “expansion board” in the specification may refer to a user interface screen on which data input by a user included in a collaboration group is written and displayed in a specific form. For example, the term “expansion board” may be a user interface screen formed in a document form (e.g., a shooting schedule) usually used in a specific industry sector (e.g., the movie making industry).

The term “card data” in the specification may refer to data displayed on a board (e.g., a main board or an expansion board) and may refer to a unit of data input or uploaded by a user. For example, the term “card data” may correspond to one post input by a specific user.

The term “default card” in the specification may refer to a default format in which card data input by a user is displayed on a board.

The term “default card data” in the specification may refer to data provided to a default card among card data.

The term “expansion card” in the specification may refer to a format in which card data input by a user is matched with a specific expansion board.

The term “expansion card data” in the specification may refer to data provided to an expansion card among card data.

Hereinafter, a description will be given in detail of a method and program for providing a collaboration service according to embodiments of the inventive concept with reference to the accompanying drawings.

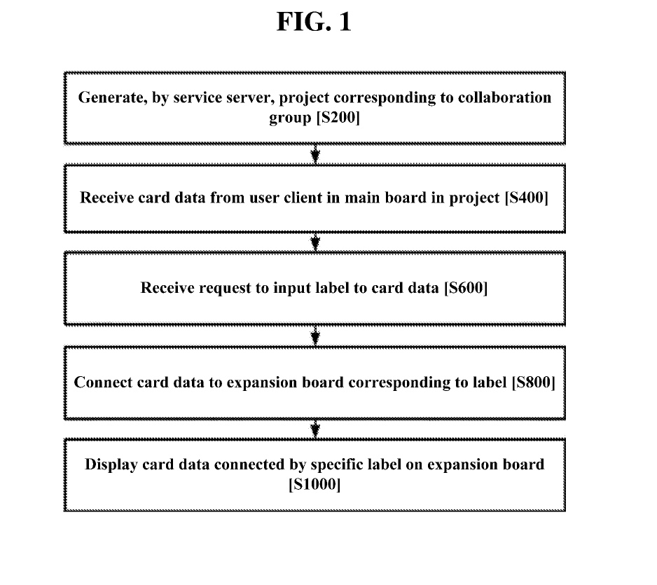

FIG. 1 is a flowchart illustrating a method for providing a collaboration service according to an embodiment of the inventive concept.

Referring to FIG. 1, the method for providing the collaboration service according to an embodiment of the inventive concept may include generating (S200), by a service server, a project corresponding to a collaboration group, receiving (S400), by the service server, card data from a user client in a main board in the project, receiving (S600), by the service server, a request to input a label to the card data, connecting (S800), by the service server, the card data to an expansion board corresponding to the label, and displaying (S1000), by the service server, card data connected by a specific label on the expansion board. Hereinafter, a detailed description will be given of each operation.

In operation S200, the service server may generate the project corresponding to the collaboration group. The service server may receive a project generation request for performing a specific task in a collaboration service from a specific user and may generate a project corresponding to the specific task in the collaboration service. The service server may receive the project generation request from the specific user through a web or application.

When the project is generated, the user may invite a member to be added to a collaboration group corresponding to the project. For example, the service server may provide a member add page when generating a project to a collaboration app or webpage. A user (i.e., a first user) who generates the project may add a user who subscribes to the collaboration service or an acquaintance, contacts of which are known to the user. When adding an acquaintance (i.e., a second user) who does not join the collaboration service to the project, the service server may transmit a collaboration service subscription request to contacts (e.g., a phone number, a social network service (SNS) account, a mail address, or the like) of the second user, received from a client device of the first user.

In operation S400, the service server may receive the card data from the user client in the main board in the project. The card data may be information input to the project by the user and may be information posted in the collaboration group. The service server may receive card data to be added to a project or space from a client device of a specific user included in the collaboration group.

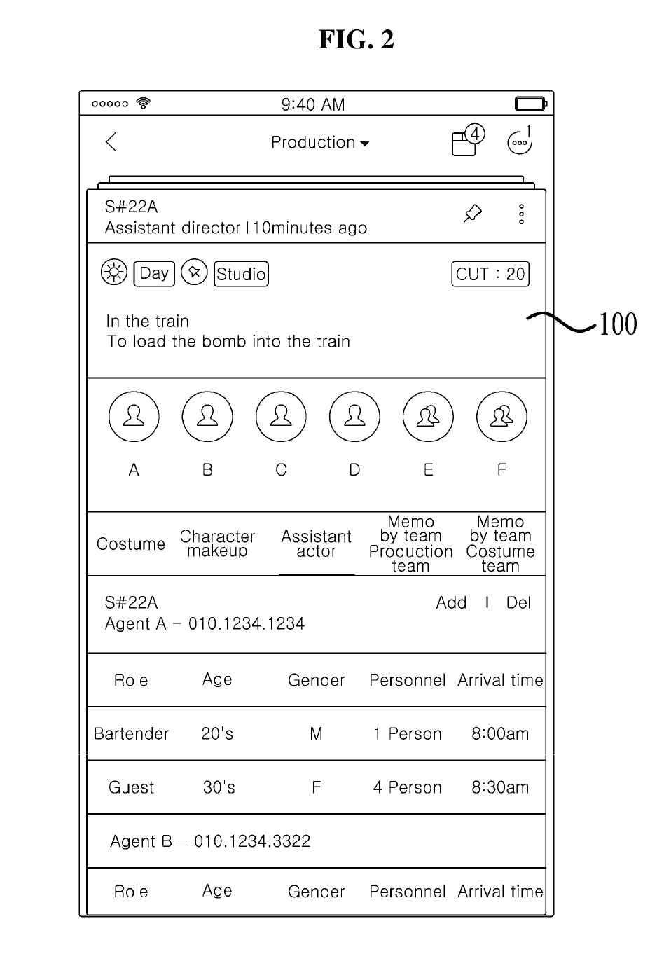

The service server may receive card data in various manners. As an embodiment, the service server may directly receive data to be written in the form of one default card 100 of FIG. 2 from the user. For example, the service server may receive card data from the user client in a form where a post is input to a bulletin board.

As another embodiment, in operation S400, the service server may receive scenario data from a specific user and may receive a request to divide the scenario data, thus generating the default data 100 corresponding to each scene. For example, when a collaboration service is used in film production, the service server may receive scenario data corresponding to all scenario files from the user (i.e., the first user) corresponding to a manager when generating a project. Thereafter, the service server may divide the scenario data for each scene. The service server may divide a scene in a unit set by the user or may divide the scene based on identification data input for identifying the scene in scenario data. Thus, the service server may generate the default card 100 corresponding to each scene.

FIG. 2 is a drawing illustrating a default card generated for each scene in film production according to an embodiment of the inventive concept. As shown in FIG. 2, a per-scene default card 100 generated based on scenario data may include information necessary for each scene. For example, when receiving information which should be shared in a collaboration group or a detailed group for a specific scene from a user, a service server may generate a detailed card in the default card 100 for each scene or may add an information label to the default card 100. The per-scene default card 100 may display several information associated with a corresponding scene. For example, the per-scene default card 100 may receive information associated with a filming location, a character, a filming date, continuity, or the like of the corresponding scene. As described below, each information may be input in a manner to add a label to the default card 100. As shown in FIG. 2, the default card 100 of a specific scene (S#22 A) may generate information associated with a filming location, a character, a character's makeup/costume, or an extra of the specific scene as each label or tap and may provide the generated label or tap.

Referring again to FIG. 1, in operation S600, the service server may receive the request to input the label to the card data. The label may correspond to specific information input to each card. The service server may add place information, time information, participant information, and the like as labels respectively corresponding to the place information, the time information, the participant information, and the like depending on the label input request of the user.

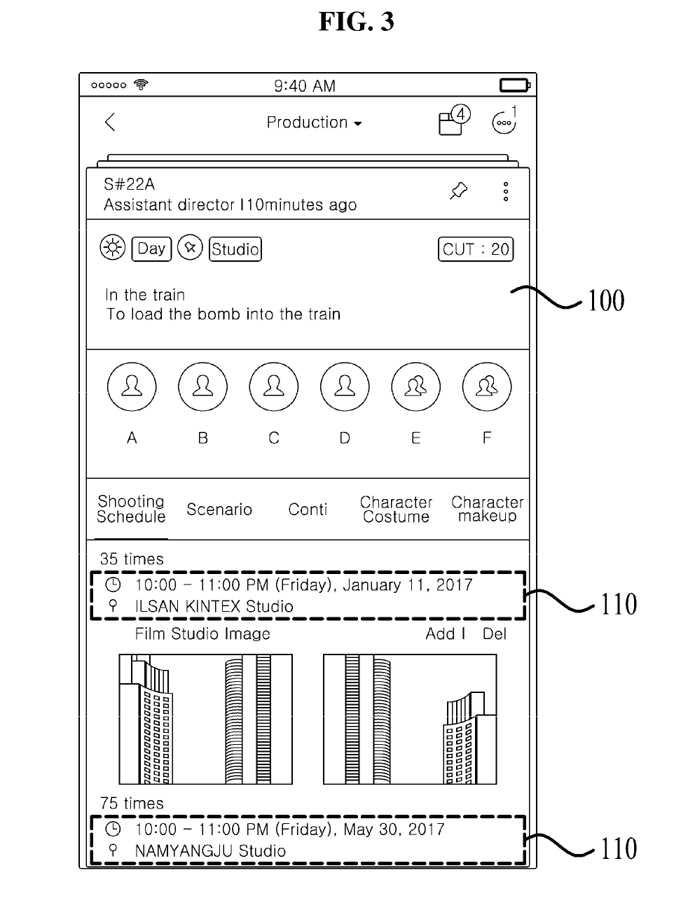

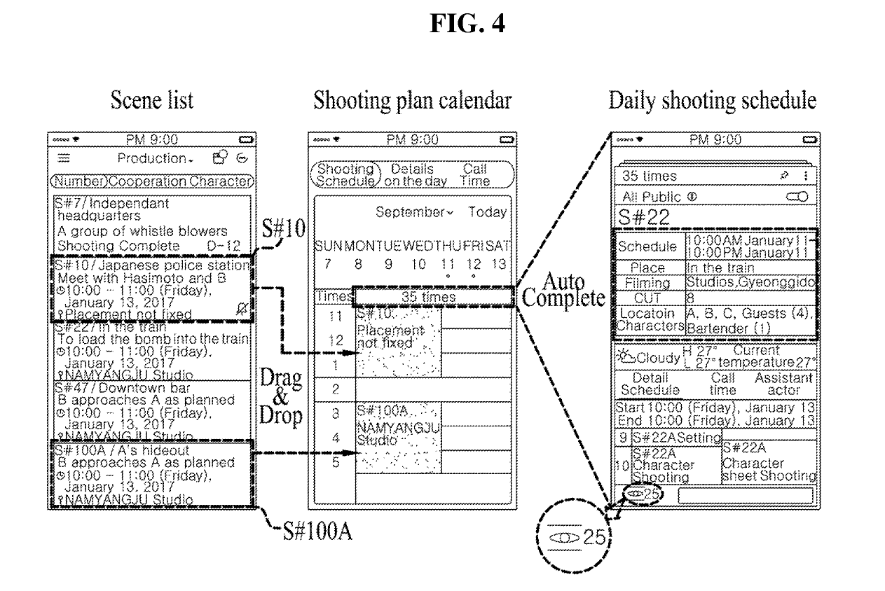

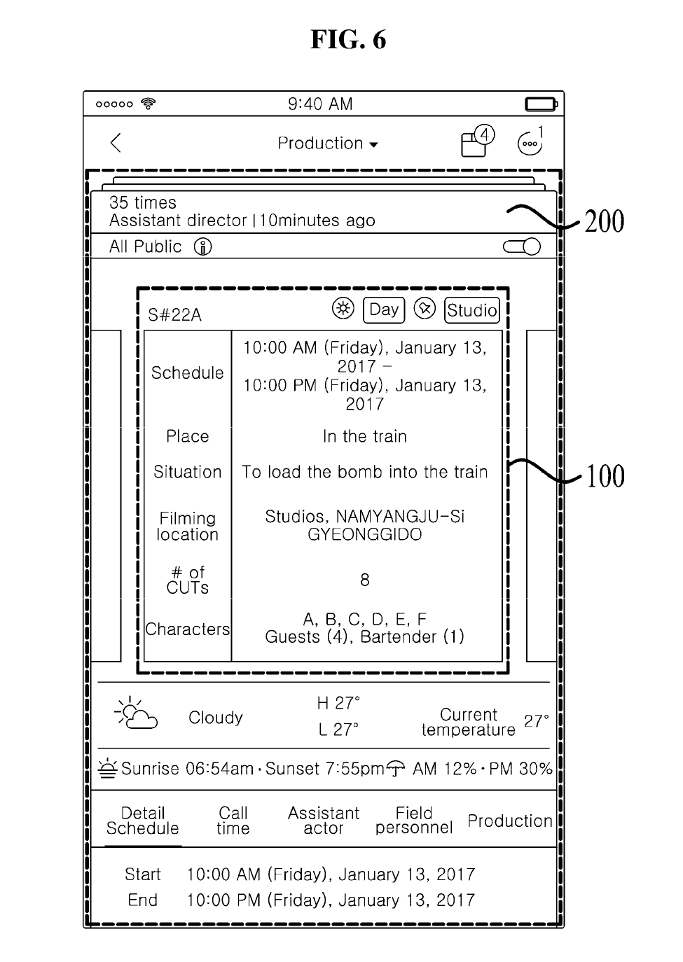

Various manners may be applied in the manner as to request to input the label. As an embodiment, the service server may select an “add” button (e.g., a “+” button) displayed on an interface of the default card 100 or an expansion card 200 of FIG. 6 and may select a label type of a label the user wants to add, thus adding the label. As another embodiment, as the user drags and drops a specific card using a tap corresponding to a specific expansion board, the user client may transmit a request to input a label necessary for the default card 100 to be displayed on the specific expansion board to the service server. For example, there may be a need for information associated with a shooting schedule for each scene to generate a shooting schedule table upon film production collaboration. Thus, as shown in FIG. 4, when the user drags and drops a specific scene card (i.e., the default card 100) using an expansion board tap or the expansion board itself corresponding to the shooting schedule table, the user client may transmit a label input request for additionally requesting to input a shooting schedule label 110 of FIG. 3 necessary to add the selected scene card to the shooting schedule table to the service server.

In operation S800, the service server may connect the card data to an expansion board corresponding to the label. In other words, when a label corresponding to information essential to connect the card data to each expansion board is added to a card, the service server may connect the card data to an expansion board matched to the label. As the label is added, an indication in a specific expansion board of specific card data may be activated. For example, the default card (i.e., the scene card) which matches the specific expansion board to each scene upon file production collaboration may be configured to be displayed on only a main board which displays each scene in an order of each scene. However, an indication in a shooting schedule table of the default card 100 may be activated as a label for a shooting schedule of a corresponding scene is added.

The expansion board may be a board of a specific format used for each situation or each industry sector. Since there is a previously used format for convenience of business for each industry sector, the expansion board may be provided in a format used in an industry sector (e.g., the movie making industry, the healthcare industry, or the like) which uses a collaboration service to maintain the usability of a previous task without change. For example, shooting may fail to be performed in an order of scenes when a shooting process is entered in the movie making industry, and a shooting schedule table may be made and used in consideration of a filming location, a schedule of an actor (or actress), or the like. A form of a shooting schedule table which is previously used after being made using the Microsoft Excel or the like may be maintained and used without change in a collaboration service, thus solving the inconvenience of having to adapt to a new form. In other words, as an expansion board matched with each industry is used, a specific format fixed in a collaboration tool may fail to be forced to be used and a collaboration service may be used in a direction specialized in each industry sector.

Furthermore, the expansion bard 200 included in the expansion board may display only information which should be displayed on the expansion board among data included in the default card 100 in a specific format. The default card 100 displayed on a main board may include a plurality of information, but, when a specific expansion board is used, all of the plurality of information may fail to be required. Thus, the service server may extract only information necessary for the expansion board from card data included in the default card 100 to configure the expansion card 200. In other words, the main board and the expansion board may display the same information (i.e., the same card data) as the default card 100 and the expansion card 200 of different formats depending on a board type.

As another embodiment, as described below, the expansion board may be added through purchase in a collaboration service. For example, the service server may include a skin selling market in the collaboration service. As the user purchases an expansion board necessary for a specific industry sector or a specific detailed situation, the expansion board may be added to a project or space corresponding to a specific collaboration group or a specific detailed group. Furthermore, when a specific user makes an expansion board for the specific industry sector or the specific detailed situation, he or she may upload the expansion board to the skin selling market to sell the expansion board.

FIG. 3 is a drawing illustrating a per-scene default card to which a schedule label is added, according to an embodiment of the inventive concept. As shown in FIG. 3, one or more schedule labels may be added to a default card 100 (i.e., a scene card) depending on a request of a user. Filming may be required to proceed in a plurality of places to film one scene, so a shooting schedule when a scene is shot in each place may be added as a schedule label. As the schedule label is added, a service server may connect a corresponding scene card to a shooting schedule card (i.e., a daily shooting schedule) of a specific filming date. Furthermore, as shown in FIG. 3, the service server may display a corresponding expansion card number (e.g., episode 35, episode 75, or the like) in a shooting schedule table board together with a corresponding schedule label in the scene card (i.e., the default card 100).

Referring again to FIG. 1, in operation S1000, the service server may display the card data connected by the specific label on the expansion board. Furthermore, in operation S1000, the service server may display an expansion card 200 modified to a format corresponding to an expansion board corresponding to the label. For example, as shown in FIG. 4, the service server may display and provide the expansion card 200 in which each scene card (i.e., the default card 100) is changed in a form matched with a shooting schedule table which is an expansion board.

FIG. 4 is a drawing illustrating a process of generating an expansion card (a daily shooting schedule) of a shooting schedule which is an expansion board based on a default card in film production according to an embodiment of the inventive concept. As shown in FIG. 4, in a daily shooting schedule card generated based on a schedule label input to a scene card which is a default card 100, a user may check a list of other users who checks a generated or changed schedule and may transmit a request to check the schedule to only a user who does not check the schedule. In other words, a service server may obtain information about a user client which checks a daily shooting schedule which is newly generated or changed and may generate a list of users who complete the checking of the daily shooting schedule, thus providing the generated list to the user. Thus, the user may transmit a request to check a shooting schedule table to only a counterpart who does not check the shooting schedule table, so unnecessary contact may be reduced.

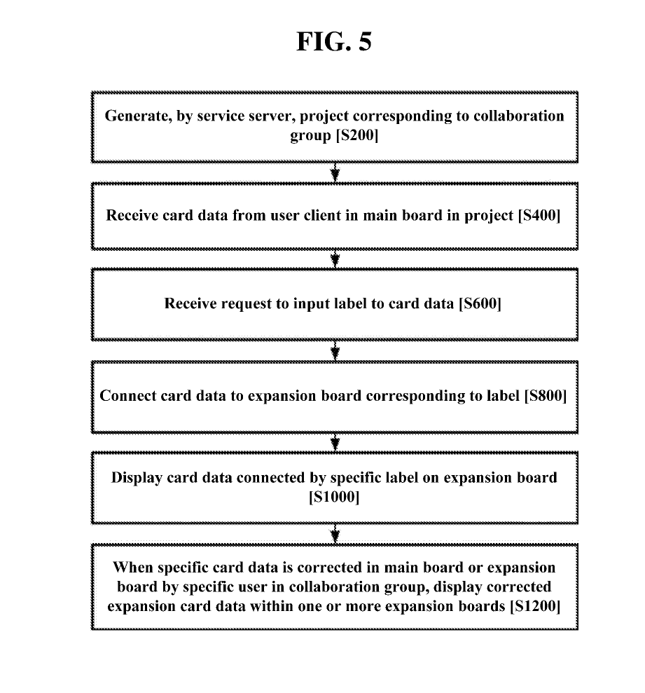

FIG. 5 is a flowchart illustrating a method for providing a collaboration service, which further includes a process of correcting a linked card depending on correction of a specific default card or expansion card according to an embodiment of the inventive concept. FIG. 6 is a drawing illustrating an expansion card (a daily shooting schedule) generated by including several cards according to an embodiment of the inventive concept. As shown in FIG. 5, the method for providing the collaboration service may further include displaying (S1200) corrected expansion card data within one or more expansion boards when specific card data is corrected on a main board or an expansion board by a specific user in a collaboration group. A default card 100 and an expansion card 200 displayed on the main board and the expansion board may display card data (i.e., default card data) which is connected by a label and is included in the default card 100 with different formats, so cards in the main board and one or more expansion boards may be corrected once as card data is corrected in a specific card.

Thus, the user who belongs to the collaboration group or a detailed group may input information, which should be shared upon collaboration, as card data to generate the default card 100 and may add a label necessary to add corresponding card data to a specific expansion card to simply generate an expansion card having a specific format. Inconvenience in which users should make a separate format using data included in the default card 100 may be solved.

Furthermore, there may be one card data in a service server and the card data may be connected to the default card 100 and an expansion card 200 by a label to be differently displayed, so all cards connected to the card data may be corrected when the card data is corrected in the specific default card 100 or the specific expansion card 200. As each form is separately made and used using the same information, existing convenience of having to searching and correcting a portion corresponding to each form when information is corrected in a specific format may be solved. For example, upon film production collaboration, when a schedule of an actor (or actress) is changed, when a filming location is changed, or when a schedule is changed according to previous shooting delay or the like, the inconvenience of having to search all daily shooting schedules associated with one change, separately correct the daily shooting schedule, and separately notifying a related interested party that the daily shooting schedule is corrected may be solved.

As another embodiment, the expansion card 200 may be formed in a format including the one or more default cards 100. In other words, the service server may merge or arrange the plurality of default cards 100 to generate the one expansion card 200. The service server may merge or arrange the default cards 100, each of which includes the same label information, to generate the specific expansion card 200. For example, upon film production collaboration, the default card 100 may be a scene card generated for each scene, and the expansion card 200 may be a per-day shooting schedule card. As a specific shooting schedule is added as a label to the default card 100, the service server may merge or arrange the default cards 100 to which a schedule label is added on the same date to generate the expansion card 200. Thus, the service server may simply generate the per-day expansion card 200 included in an expansion board which is a shooting schedule table and may simply correct all boards by correcting information in a main board or an expansion board.

For example, when film production collaboration is performed, as shown in FIG. 6, the service server may generate and display the default card 100 (i.e., the scene card) shot on a specific date within a daily shooting schedule card of the date to be matched with an expansion card. In other words, the service server may extract only information necessary for a daily shooting schedule card which is the expansion card 200 from a plurality of information included in the default card 100 corresponding to each scene and may display the extracted information within the expansion card 200. As shown in FIG. 6, the default card 100 (i.e., the scene card) displayed on the expansion card 200 may extract only information associated with a schedule, a place in the movie, a situation, a filming location, the number of cuts, a character, or an extra from all card data and may provide the extracted information.

Moreover, since several scenes are shot on the same date upon filming, the expansion card 200 may provide a user interface to simultaneously display the several default cards 100 (i.e., several scenes) or sequentially check several scene cards included within the same shooting episode depending on a user operation. As shown in FIG. 6, the service server may receive an operation of swiping a portion where the default card 100 in the expansion card 200 is displayed left and right from a user and may provide another default card (i.e., another scene card) within the same episode to a user client.

Furthermore, a daily shooting schedule card which is the expansion card 200 may combine card data included in the plurality of default cards 100 and may display the combined card data to be matched with the expansion card 200. For example, as shown in FIG. 6, the service server may combine a plurality of information included in each scene card to generate information to be included in a tap such as a detailed schedule, an extra, or a site schedule of a lower end.

Further, the expansion card 200 may further include necessary information other than the information included in the default card 100. For example, as shown in FIG. 6, a daily shooting schedule card which is the expansion card 200 may receive calltime information which is not included in a scene card which is the default card 100 and may include the received calltime information as a separate tap. Since the calltime information is an item associated with shooting on a corresponding date rather than information about each of scenes, the service server may separately provide a calltime tap in the expansion card 200 and may receive calltime information of each cast from a manager.

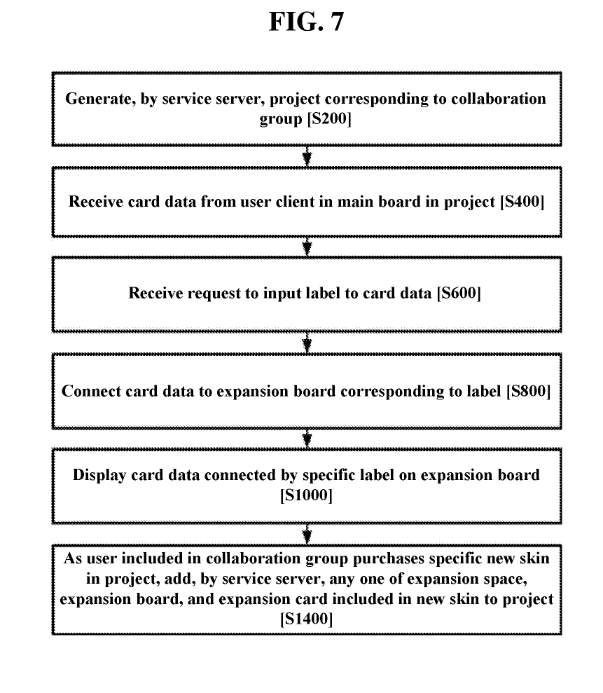

FIG. 7 is a flowchart illustrating a method for providing a collaboration service, which further includes a process of adding a new skin to a project or space according to an embodiment of the inventive concept. As shown in FIG. 7, the method for providing the collaboration service may further include, as a user included in a collaboration group purchases a specific new skin in a project, adding (S1400) any one of an expansion space, an expansion board, and an expansion card 200 included in the new skin to the project. The service server may provide a market capable of purchasing a skin in a collaboration service. The skin may refer to a specific expansion board, the specific expansion card 200, a specific expansion space, or the like available when the collaboration service is used. As the user included in the collaboration group purchases a new skin in a market, the service server may apply the new skin to a project of the collaboration group. The new skin may be made by a service provider or another user and may be uploaded to the market. The market may include both of a web and a path capable of adding an element which is accessed through the app and is applicable to the collaboration service.

The expansion card 200 may be a card with a different format in which information is displayed, in a main board or an expansion card which is previously purchased. In other words, the expansion card 200 may be generated in a format where information is more easily checked than an existing card used in the collaboration service or may be formed in a format capable of adding more data types (e.g., a video, a photo, and the like).

The expansion board may be a board of a format suitable for a specific industry sector or situation other than other than a board basically provided in the collaboration service. As the user requests to add a new expansion board, the service server may add the expansion board to an added project or space. Thus, users may add an expansion board in a form necessary for collaboration of a specific industry sector and may perform efficient collaboration. The expansion board may include the one or more expansion cards 200 having a format matched with the expansion card to be provided.

The expansion space may be a skin including one or more boards specialized in a specified detailed group and the expansion card 200. For example, boards necessary for a specific detailed group corresponding to a finance team in a collaboration group to collaborate a finance task may be generally determined. Thus, the service server may add a space specialized in a detailed group which performs a specific task to a project depending on a request to add an expansion space.

As a new skin is able to be added, diversity of business and a variety of usability of users may be ensured in one collaboration service. Furthermore, as a skin specialized for each industry sector is provided, business efficiency may be increased using a collaboration service irrespective of the industry sector.

As another embodiment, the card data may include related user information as a label in a corresponding card. When the card data is corrected, the service server may notify only a user included in information about interested parties that the card data is corrected. When a collaboration service provides an unnecessary notification to a user included in a collaboration group, the user may become insensitive to notification of the collaboration service and may fail to response to a quick response, so there is a need for specifying (targeting) only a user who is required to receive specific information and providing a notification to the user. To this end, the service server may add related user information to card data and may provide a notification to only a user included in the related user information when the card data is input or corrected.

For example, upon film production collaboration, the default card 100 (i.e., the scene card) corresponding to a specific scene may add a user (e.g., an actor (or actress), a shooting team, or the like) who is involved in filming the scene as related user information. When card data of a scene card is corrected as a filming location or schedule of the scene is changed, the service server may notify a user included in the related user information that the scene is corrected.

Hereinafter, a description will be given of an example of using the method for providing the collaboration service according to embodiments of the inventive concept in film production.

When the collaboration service is used for film production/filming, the default card 100 may be generated for each scene included in a scenario. The default card 100 (i.e., the scene card) generated for each scene may be arranged in an order of scenes on a main board. In other words, the main board may correspond to a movie scenario, and each scene card may be generated as scenario data is uploaded to a service server by a user.

Furthermore, the scene card may include a plurality of information associated with each scene (i.e., information necessary to shoot the scene). For example, the scene card may include a filming location, a shooting schedule, continuity, an actor (or actress), and the like as card data, and each information may be added to a card in the form of a label.

One of the expansion cards may correspond to a shooting schedule. The expansion card 200 in the expansion board corresponding to the shooting schedule table may be a shooting schedule for each filming date and may be assigned in order of filming date. The expansion card 200 included in the shooting schedule table may be a card generated by merging or arranging the plurality of default cards 100, each of has a schedule label in which a specific date is set to a filming date. In other words, the service server may display the expansion card 200 on a shooting schedule table expansion board as a user inputs a filming date/time (i.e., adds a shooting schedule label) to the scene card (i.e., the default card 100). The service server may modify and display the scene card (i.e., the default card 100) in the form of being suitable for being displayed on a shooting schedule table. Furthermore, the service server may collect scene cards shot on the same date to generate the one expansion card 200.

Thus, as a collaboration service including the method for providing the collaboration service according to embodiments of the inventive concept is used upon film production, users may fail to make a shooting schedule table based on a scenario and information about each scene. When only schedule information is added to a scene card generated for each scene, a shooting schedule table may be automatically generated. When a shooting schedule of a specific scene is changed, changes may be automatically applied to the shooting schedule table. In other words, when a filming date of a scene corresponding to the specific default card 100 is changed, the service server may automatically change and generate the expansion card 200 (i.e., a shooting schedule card of a specific date) including the default card 100.

In some embodiments, the above-discussed method of FIG. 1, according to this disclosure, is implemented in the form of program being readable through a variety of computer means and be recorded in any non-transitory computer-readable medium. Here, this medium, in some embodiments, contains, alone or in combination, program instructions, data files, data structures, and the like. These program instructions recorded in the medium are, in some embodiments, specially designed and constructed for this disclosure or known to persons in the field of computer software. For example, the medium includes hardware devices specially configured to store and execute program instructions, including magnetic media such as a hard disk, a floppy disk and a magnetic tape, optical media such as CD-ROM (Compact Disk Read Only Memory) and DVD (Digital Video Disk), magneto-optical media such as floptical disk, ROM, RAM (Random Access Memory), and flash memory. Program instructions include, in some embodiments, machine language codes made by a compiler compiler and high-level language codes executable in a computer using an interpreter or the like. These hardware devices are, in some embodiments, configured to operating as one or more of software to perform the operation of this disclosure, and vice versa.

A computer program (also known as a program, software, software application, script, or code) for the above-discussed method of FIG. 1 according to this disclosure is, in some embodiments, written in a programming language, including compiled or interpreted languages, or declarative or procedural languages. A computer program includes, in some embodiments, a unit suitable for use in a computing environment, including as a stand-alone program, a module, a component, or a subroutine. A computer program is or is not, in some embodiments, correspond to a file in a file system. A program is, in some embodiments, stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program is, in some embodiments, deployed to be executed on one or more computer processors located locally at one site or distributed across multiple remote sites and interconnected by a communication network.

According to the above-mentioned embodiments of the inventive concept, there are the following various effects.

First, an information providing page (i.e., a board) suitable each industry sector may be provided to be simply written, so users of each industry sector may perform efficient business.

Secondly, a label necessary to add corresponding card data to a specific expansion board may be added to simply generate the expansion board having a specific format. Inconvenience in which users should make a separate format using data included in a default card may be solved.

Finally, there may be only one card data in a service server and the card data may be connected to a default card and an expansion card by a label to be differently displayed, so all cards connected to the card data may be corrected when the card data is corrected in the specific default card or the specific expansion card. Existing inconvenience of having to search and correct a portion corresponding to each format when information is corrected in a specific format as each format is separately made and used using the same information may be solved.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method for providing a collaboration service, the method comprising:
generating, by a service server, a project corresponding to a collaboration group;
receiving, by the service server, card data from a user client in a main board in the project and generating, by the service server, a default card, the card data being information input to the project;
receiving, by the service server, a request to input a label to the card data;
connecting, by the service server, the card data to an expansion board corresponding to the label; and
displaying, by the service server, card data connected by a specific label on the expansion board,
wherein the expansion board is a board of a specific format used for each situation or each industry sector.

2. The method of claim 1, wherein the connecting of the card data comprises:
displaying an expansion card modified to a format corresponding to the expansion board corresponding to the label.

3. The method of claim 1, wherein the project comprises one or more spaces; and
wherein the space corresponds to one or more detailed groups in the collaboration group.

4. The method of claim 1, further comprising:
as a user included in the collaboration group purchases a specific new skin in the project, adding, by the service server, any one of an expansion space, an expansion board, and an expansion card included in the new skin to the project,
wherein the purchasing of the new skin is performed in a market in a collaboration service.

5. The method of claim 1, wherein the expansion board is generated based on a format used in a specific field, and
wherein an expansion card included in the expansion board displays only information which should be displayed on the expansion board in a specific format among data included in the default card.

6. The method of claim 1, further comprising:
when a specific card data is corrected in the main board or the expansion board by a specific user in the collaboration group, displaying, by the service server, the corrected expansion card data within one or more expansion boards,
wherein the main board and the expansion board display the same information as default card data and expansion card data of different formats depending on a board type.

7. The method of claim 1, wherein the card data comprises related user information as a label in a corresponding card,
further comprising:
when the card data is corrected, notifying only a user included in information about an interested party that the card data is corrected.

8. The method of claim 1, wherein, when a collaboration service is used for filming, the default card is generated for each scene included in a scenario, the expansion board corresponds to a shooting schedule, and an expansion card included in the shooting schedule is a card generated by merging a plurality of default cards where a specific date is set to a filming schedule in a schedule label and is assigned in order of filming date.

9. The method of claim 1, wherein the receiving of the card data comprises:
receiving a request to divide scenario data; and
generating a default card corresponding to each scene.

10. A program for providing a collaboration service, the program being stored in a medium to be combined with a computer which is hardware and perform the method of claim 1.
